(19) United States
(12) Patent Application Publication
(10) Pub. No.: US 2015/0030430 A1
(43) Pub. Date: Jan. 29, 2015

(54) WATER TURBINE

(71) Applicants: Chee Wah Hon, Singapore (SG); Bert De Wijs, Singapore (SG)

(72) Inventors: Chee Wah Hon, Singapore (SG); Bert De Wijs, Singapore (SG)

(73) Assignee: ENGTEK PTE LTD, Singapore (SG)

(21) Appl. No.: 14/373,098

(22) PCT Filed: Dec. 12, 2011
(86) PCT No.: PCT/SG2011/000433

§ 371 Date: Jul. 18, 2014

(51) Int. Cl. F03B 3/04; F03B 11/02; F03B 13/10

(52) U.S. Cl. CPC F03B 3/04; F03B 13/10; F03B 11/02
USPC 415/1; 415/68

(57) ABSTRACT

This invention is relates to water turbine power. In particular, the invention relates to a water turbine for generating power in a body of water. There is provided a turbine for operation in a body of water for the generation of power, the turbine comprising: (a) a housing having an inlet for receiving water and an outlet for allowing water to exit; and (b) a power generation unit disposed in the housing and intermediate the inlet and outlet, the power generation unit comprising two propellers for rotation about an axis in response to water flow, wherein the inlet comprises a flared outer end for channelling the water towards the power generation unit, and a truncated cone disposed within the flared outer end of the inlet, the flared portion of the truncated cone protrudes the inlet.

### FIELD OF THE INVENTION

This invention is relates to water turbine power. In particular, the invention relates to a water turbine for generating power in a body of water.

### BACKGROUND OF THE INVENTION

A water turbine is an energy conversion system which converts kinetic water energy into electrical energy for utility power grids. Specifically, water is applied to the turbine blades of the water turbine to rotate a rotor. The mechanical energy of the rotating rotor in turn is converted into electrical energy by an electrical generator.

Water turbines are generally considered a clean power producer, as the turbine causes essentially no change to the water. They use a renewable energy source and are designed to operate for decades. They produce significant amounts of the world's electrical supply. However, present water turbines require large propeller blades and deep water depth in order to generate the desired amount of energy and power required for power grids.

A number of designs of water turbine have been proposed for generating power from moving bodies of water, including in rivers and in marine applications. However, none allows portability and yet provide the desired amount of energy required. In particular, there does not exist a water turbine that is small, portable, easy to install and inexpensive and yet able to produce the required power output. The present invention aims to solve a number of problems in these existing designs.

### SUMMARY OF THE INVENTION

In a first aspect of the invention, there is provided a turbine for operation in a body of water for the generation of power, the turbine comprising: (a) a housing having an inlet for receiving water and an outlet for allowing water to exit; and (b) a power generation unit disposed in the housing and intermediate the inlet and outlet, the power generation unit comprising two propellers for rotation about an axis in response to water flow, wherein the inlet comprises a flared outer end for channelling the water towards the power generation unit, and a truncated cone disposed within the flared outer end of the inlet, the flared portion of the truncated cone protrudes the inlet.

By “body of water”, it is meant to include rivers, streams, canals, tidal bays, oceans and other flowing water environments.

By “inlet”, it is meant to include any structure or means that allow for water to enter into the turbine. By “outer end”, it is meant to refer to the end furthest away from the power generation unit. The “inner end” of the inlet would be that end nearest the power generation unit. Preferably, the outer end of the inlet forms part of the exterior of the housing of the turbine. By “flared outer end”, it is meant to refer to an increase in size from the inner end to the outer end of the inlet. In preferred embodiment, the inlet is cylindrical and, preferably, the increase in diameter of the inlet towards the outer end is gradual.

By “truncated cone”, it is meant to refer to any structure that is left where a cone is cute by a plane parallel to the base and the apical part is removed. Both the inlet and the truncated cone allows the flow of water through and channels the water towards the power generation unit. Advantageously, this increases the area in which water is drawn into the turbine and towards the propellers of the power generation unit. This configuration allows for the increase in the mass flow velocity of the water. The, higher the velocity of the water, the faster the propellers will spin. This, in turn, increases the power generated by the turbine.

Preferably, wherein the inlet and truncated cone is Venturi-shaped.

By “Venturi”, it is meant to include any structure or device having a constricted throat in the passage of any fluid, thereby causing a reduction in pressure that result in the movement of fluid in a given direction.

Preferably, the inlet and truncated cone comprise guides for channelling the water to the blade assembly.

Preferably, the two propellers rotate about the axis in opposite directions. Advantageously, this doubles the power output of the turbine for its given size.

Preferably, the housing further comprising an outlet having a flared end.

Preferably, the housing further comprising an inlet for introducing air into the water before the water enters the power generation unit.

Advantageously, the turbine of the present invention is smaller in size relative to the output power it can generate. This is due to the fact of the two inlets and two propellers rotating in opposite directions. A turbine without these features would be approximately three times larger and therefore may be not be practical or portable on many river systems.

In a second aspect of the invention, there is provided a method for generating electricity using a turbine according to the first aspect of the invention.

### BRIEF DESCRIPTION OF THE FIGURES

In order that the present invention may be fully understood and readily put into practical effect, there shall now be described by way of non-limitative examples only preferred embodiments of the present invention, the description being with reference to the accompanying illustrative figures.

In the Figures:

FIG. 1 is a cross-section view of the turbine according with an embodiment of the present invention; and

FIG. 2 is a perspective view of FIG. 1.

### DETAILED DESCRIPTION OF THE PREFERRED EMBODIMENTS

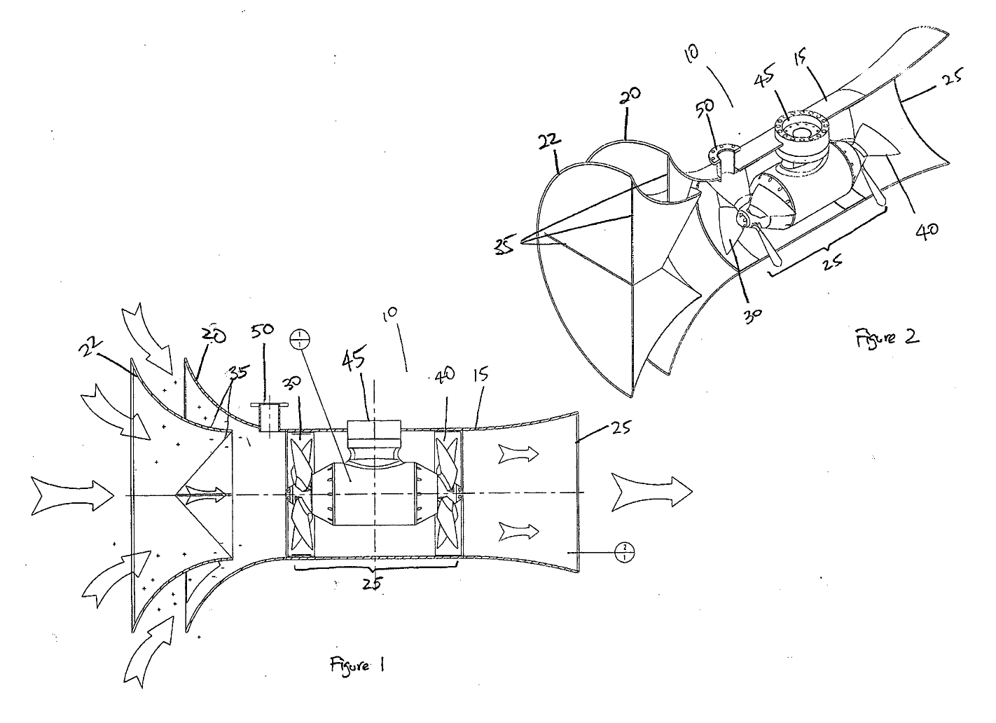

Referring to the accompanying Figures, FIG. 1 shows a turbine 10 that may be used for operation in a body of water in order to generate energy and electricity.

The turbine 10 includes a housing 15 having an inlet 20 and an outlet 25. A power generation unit 25 is housed in the housing and intermediate the inlet 20 and outlet 25. The inlet 20 has a flared outer end that is furthest away from the power generation unit 25. The power generation unit 25 has at least two propellers 30, 40 for rotation about an axis in response to water flow. Water flow is depicted by the arrows shown in FIG. 1. The inlet 20 receives and channels the water to the propellers 30, 40 of the power generation unit 25. Water then leaves and exits the turbine 10 at the outlet 25.

In an exemplary embodiment of the invention, a truncated cone 22 is disposed within the inlet 20. The flared portion of the truncated cone 22 protrudes the inlet 20. Water Both the inlet 20 and the truncated cone 22 receives water into the turbine (as shown by the arrows) and may be Venturi-shaped as depicted in the Figures. From the Figures, it can be seen that the end furthest away from the power generation unit 25 is wider than the end nearer the power generation unit 25. In other words, the inlet 20 and truncated cone 22 have a constricted throat nearer the power generation unit 25 and this results in reduction in pressure in the water entering the turbine 10. The difference in pressure is represented by “+” (higher pressure) and “−” (lower pressure) in the Figures. As water enters the inlet 20 and truncated cone 22, a pressure drop occurs across the length of the inlet 20 and truncated cone 22. A lower pressure “−” exists nearer the power generation unit 25 compared to the entrance of the turbine 10; this in effect causes a larger increase in the mass flow of the turbine 10 and at an accelerated rate of flow. In other words, it is this difference in pressure that allows more water to be drawn in faster into the turbine 10 to turn the propellers 30, 40 of the power generation unit 25, i.e. it accelerates the flow of water through the turbine 10.

Both inlet 20 and the truncated cone 22 have a smooth inner surface to decrease drag forces since the purpose of the inlets is to accelerate the mass flow of water. Typical construction material will be either cast steel or fabricated steel plate.

The inlet 20 and the truncated cone 22 may also be called nozzles. The shape of these nozzles produce a sub atmosphere of low pressure behind the turbine 10, allowing the turbine 10 to operate at higher efficiencies, typically much higher then the Betz Limit of 59.3%, than it would otherwise be capable of in free stream or open flow with a turbine 10 of the same diameter.

Advantageously, the arrangement of the present invention allows water to enter the turbine 10 via the inlet 20 and the truncated cone 22 increases the mass flow rate of the water. This means that the turbine 10 is capable of higher efficiencies as much as 3-4 times the power of the same turbine in an open flow condition (without the flared outer end inlet and truncated cone). Efficiencies of close too 100% are possible because the inlets effectively facilitate the extraction of energy from a water cross-section equal to the size of the inlet rather then the size of the turbine. A turbine the same size as the diameter of the duct opening will generate a similar amount of electricity.

The inlets 20 and the truncated cone 22 may comprise guides 35 for channelling the water to the power generation unit 25.

With regard to the power generation unit 25, the propellers 30, 40 may be contra-rotating propellers. This means that the two propellers 30, 40 rotate about the same axis in opposite directions. These propellers 30, 40 allow recovery of the maximum power available in a water flow condition. Typically, the two propellers 30, 40 are arranged one behind the other, and kinetic energy is converted rotationally to the turbine 10. The propellers 30, 40 may be disposed close to each other or at a distance suitable to generating the desired power. The propellers 30, 40 should be arranged as close as possible to each other so that the second propeller 40 downstream the water flow can pick up the rotational energy from the first propeller 30. The distance between the propellers 30, 40 is dependent on the length of the stators and therefore should be as short as possible. If the propellers 30, 40 are further apart, the rotational energy will be lost.

Water flowing with high mass of water through the dual propeller power generation unit 25 causes a significant amount of tangential or rotational water flow to be created by the spinning blades. The energy of this tangential water flow is wasted in a single-propeller turbine design. The present turbine 10 uses this wasted effort by the placement of a second propeller 40 behind the first 30 which takes advantage of the disturbed water flow.

Advantageously, the present power generation unit 25 will have no rotational water flow, producing a maximum amount of water uniformly through a propeller disk, resulting in high performance and low induced energy loss. Preferably, the two propellers 30, 40 may have a different number of blades (e.g. four blades on the forward propeller and five on the aft).

The contra-rotating propellers allow maximum power and efficiency under normal operating conditions, and also the ability to operate only one of the propellers when one of the other propeller is down during periods when full power is not required or for maintenance requirements.

The propellers may use Kaplan style propellers for the turbine which act as an inward flow reaction turbine, which means that the working fluid changes pressure as it moves through the turbine and gives up its energy.

A motor assembly 45 is disposed between the two propellers 30, 40. Each propeller may have it's own motor and includes a stator section, a rotor section, drive shaft, support bearings and a seal assembly that are associated with each propeller. The two propellers 30, 40 may work independently from each other. For example, each propeller unit may have an output of about 100 kW. Hence, in the present two-propeller turbine, the total capacity of the power generated is doubled (e.g. 200 kW). The power output may vary depending on the size of the propellers and, hence, turbine. In order to generate energy from the rotating propellers, the motor assembly 45 incorporates an alternator or a dynamo. In order to minimise overall weight and size, a permanent-magnet motor may be used. These motors use high energy magnets made of neodymium or other strategic elements known to the skilled person. With their higher flux density, electric machines with high energy permanent magnets are at least competitive with all optimally designed singly fed synchronous and induction electric machines. The turbine 10 produces a DC voltage that may be fed and connected to a VFD (variable frequency drive) controller. The VFD controller will convert the DC to an AC, and also adjust the voltage and frequency. This ensures that the turbine 10 produces a constant frequency power to a power grid so that such an output may then be connected to a power grid.

Water exists the housing 15 of the turbine 10 at outlet 25. The outlet 25 is flared at the end furthest away from the power generation unit 25. This outlet 25 is a specially shaped draft tube that helps decelerate the water and recover additional kinetic energy. The flared end also allows the water flow to decelerate before re-entering the body of water so as to minimise any potential damage to the bank or bottom of the water body.

The turbine 10 may include an inlet 50 for introducing air into the water before the water enters the power generation unit 25. This allows for the water to be aerated when returned to the body of water. Such aerated water may be beneficial to the life forms that may exist in the body of water.

Advantageously, the turbine 10 will be cabled to shore or the mainland where they can be grid connected or can be scaled down to provide energy to remote communities where large civil infrastructures are not viable. It may be floated under a pontoon or fixed to the seabed/river. The present invention may be used to extract “potential energy” if the turbine 10 is positioned in a way such that the difference in height (or head) between high and low tides may be used to drive the power generation unit 25. The dimensions of the turbine 10 may vary according to the power output needs required.

Whilst there has been described in the foregoing description preferred embodiments of the present invention, it will be understood by those skilled in the technology concerned that many variations or modifications in details of design or construction may be made without departing from the present invention.

1. A turbine for operation in a body of water for the generation of power, the turbine comprising:
a housing having an inlet for receiving water and an outlet for allowing water to exit; and
a power generation unit disposed in the housing and intermediate the inlet and outlet, the power generation unit comprising two propellers for rotation about an axis in response to water flow;
wherein the inlet comprises a flared outer end for channelling the water towards the power generation unit, and a truncated cone disposed within the flared outer end of the inlet, the truncated cone having a flared portion that protrudes the inlet.

2. The turbine according to claim 1, wherein the inlet and truncated cone is Venturi-shaped.

3. The turbine according to claim 1, wherein the inlet and truncated cone comprise guides for channelling the water to the blade assembly.

4. The turbine according to claim 1, wherein the two propellers rotate about the axis in opposite directions.

5. The turbine according to claim 1 wherein the outlet comprises an outer flared end.

6. The turbine according to claim 1, wherein the housing further comprising an inlet for introducing air into the water before the water enters the power generation unit.

7. (canceled)

8. A method for generating electricity using a turbine according to claim 1.
